(19) United States
(12) Patent Application Publication
(10) Pub. No.: US 2025/0318022 A1
(43) Pub. Date: Oct. 9, 2025

(54) HYBRID HEATING DEVICE AND AEROSOL-GENERATING DEVICE

(71) Applicant: SHENZHEN FIRST UNION TECHNOLOGY CO., LTD., Shenzhen, Guangdong Province (CN)

(72) Inventors: Jiamao LUO, Shenzhen, Guangdong Province (CN); Zuqiang QI, Shenzhen, Guangdong Province (CN); Xinlei LI, Shenzhen, Guangdong Province (CN); Huanjie HE, Shenzhen, Guangdong Province (CN); Zongping YU, Shenzhen, Guangdong Province (CN); Yaodong OU, Shenzhen, Guangdong Province (CN); Baoling LEI, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/709,832

(22) PCT Filed: Nov. 15, 2022
(86) PCT No.: PCT/CN2022/132080

§ 371 Date: May 14, 2024

(30) Foreign Application Priority Data
Nov. 16, 2021 (CN) 202111357951.0

(51) Int. Cl. H05B 6/10; A24F 40/465; A24F 40/485

(52) U.S. Cl. CPC H05B 6/108; A24F 40/465; A24F 40/485

(57) ABSTRACT

A hybrid heating device and an aerosol-generating include an airflow heater, located upstream of an aerosol substrate, and configured to heat an airflow flowing to the aerosol substrate; a compensation heater, arranged in a staggered manner from an upstream section of the aerosol substrate, and configured to heat the aerosol substrate; and a connecting pipe, configured to accommodate at least the upstream section of the aerosol substrate. The compensation heater is located behind the upstream section of the aerosol substrate, and heat generated by the compensation heater can increase the temperature of the aerosol substrate of the corresponding section, so that the temperature of the airflow heated by the airflow heater can be prevented from decreasing. It is ensured that the airflow heated by the airflow heater continues to bake the aerosol substrate outside of the upstream section, to make the aerosol substrate generate a sufficient amount of volatiles.

### CROSS-REFERENCE TO RELATED APPLICATIONS

This application claims priority to Chinese Patent Application No. 202111357951.0, entitled “HYBRID HEATING DEVICE AND AEROSOL-GENERATING DEVICE” and filed with the China National Intellectual Property Administration on Nov. 16, 2021, which is incorporated herein by reference in its entirety.

### TECHNICAL FIELD

Embodiments of the present invention relate to the field of aerosol generating technologies, and in particular, relate to a hybrid heating device and an aerosol-generating device.

### BACKGROUND

An aerosol-generating device usually includes a heater and a power supply assembly, the power supply assembly is configured to supply power to the heater, and the heater is configured to heat an aerosol substrate to generate an aerosol.

The existing heater is usually a contact heater, which heats the aerosol substrate (such as cigarette) through central heating or circumferential heating. This heating manner is mainly heating the aerosol substrate through direct heat conduction. However, the contact heating manner has a defect of uneven heating, that is, the temperature of the part in direct contact with a heating element is high, and the temperature of the part far away from the heating element decreases rapidly. Therefore, only the aerosol substrate close to the heating element can be completely baked, which causes the part of the aerosol substrate far away from the heating element to fail to be completely baked. This not only results in a large waste of the aerosol substrate, but also causes an insufficient amount of aerosols. If the temperature of the heating element is increased to improve baking efficiency, it easily causes the aerosol substrate near the heating element to be burned or carbonized, which not only affects the taste, but even leads to a large increase in harmful ingredients.

A typical non-contact heater used in an aerosol-generating device in the related art adopts an airflow heating manner. This manner is mainly heating an airflow flowing into the aerosol substrate and using fluidity of the high-temperature airflow to heat the aerosol substrate, thereby ensuring that the airflow fully exchanges heat with the aerosol substrate. However, during the high-temperature airflow exchanging heat with the aerosol substrate, the temperature gradually decreases. As a result, the aerosol substrate located in a downstream part of the airflow cannot be fully baked by the high-temperature airflow to generate a sufficient amount of volatiles. This not only affects the taste, but also results in a large waste of the aerosol substrate.

### SUMMARY

An object of embodiments of this application includes providing a hybrid heating device and an aerosol-generating device, to bake an aerosol substrate by heating an airflow, and ensure full evaporation of the aerosol substrate by performing heating compensation on the heated airflow.

An aerosol-generating device provided in the embodiments of this application includes:
an elongated cavity, configured to accommodate at least a part of an aerosol substrate;
an airflow heater, located upstream of the cavity, and configured to heat an airflow flowing to the cavity; and
a compensation heater, located in the cavity or arranged adjacent to the cavity, and configured to heat a local section of the aerosol substrate, where
the compensation heater is constructed to be spaced apart from the airflow heater in a longitudinal direction of the cavity, to enable a part of the aerosol substrate to be located between the compensation heater and the airflow heater when the aerosol substrate is accommodated into the cavity.

A hybrid heating device used in an aerosol-generating device provided in the embodiments of this application is configured to heat an aerosol substrate to generate an aerosol, and includes:
an airflow heater, configured to heat an airflow;
a compensation heater, spaced apart from the airflow heater, and configured to heat a local section of the aerosol substrate; and
a connecting pipe, connected between the airflow heater and the compensation heater, where the connecting pipe is constructed to accommodate a part of the aerosol substrate and accommodate the airflow heated by the airflow heater, to enable the airflow to enter the aerosol substrate.

The embodiments of this application provide an aerosol-generating device, including the hybrid heating device.

In the hybrid heating device and the aerosol-generating device, the compensation heater is located behind the upstream section of the aerosol substrate, and heat generated by the compensation heater can increase the temperature of the aerosol substrate of the corresponding section, so that the temperature of the airflow heated by the airflow heater can be prevented from decreasing. Therefore, it can be ensured that the airflow heated by the airflow heater continues to bake the aerosol substrate outside of the upstream section, to make the aerosol substrate generate a sufficient amount of volatiles.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic exploded view of an airflow heater according to an embodiment of this application;

FIG. 2 is a schematic diagram of assembly of an airflow heater according to an embodiment of this application;

FIG. 3 is a cross-sectional view of an airflow heater according to an embodiment of this application;

FIG. 4 is a schematic diagram of an upper connecting sleeve in an airflow heater according to an embodiment of this application;

FIG. 5 is a schematic diagram of a lower connecting sleeve in an airflow heater according to an embodiment of this application;

FIG. 6 is a schematic diagram of a susceptor according to an embodiment of this application;

FIG. 7 is a cross-sectional view of a susceptor according to an embodiment of this application;

FIG. 8 is a cross-sectional view of another susceptor according to an embodiment of this application;

FIG. 9 is a schematic diagram of a magnetic inductor according to an embodiment of this application;

FIG. 10 is a schematic partial view of a susceptor with a foam structure according to an embodiment of this application;

FIG. 11 is a schematic diagram of an aerosol-generating device according to an embodiment of this application;

FIG. 12 is a cross-sectional view of an airflow heater according to another embodiment of this application;

FIG. 13 is a top view of an airflow heater according to still another embodiment of this application;

FIG. 14 is a top view of an airflow heater according to still another embodiment of this application;

FIG. 15 is a top view of an airflow heater according to still another embodiment of this application;

FIG. 16 is a cross-sectional view of a hybrid heating device according to still another embodiment of this application;

FIG. 17 is a schematic diagram of a hybrid heating device according to still another embodiment of this application;

FIG. 18 is a schematic diagram of a flattened resistive heating element according to another embodiment of this application;

FIG. 19 is a schematic diagram of assembly of a hybrid heating device according to an embodiment of this application;

FIG. 20 is a cross-sectional view of a hybrid heating device according to an embodiment of this application; and

FIG. 21 is a schematic diagram of curves of detection results of temperature distribution detection performed by using an aerosol substrate with an axial length of 20 mm as an example.

In the figures:
1. cigarette; 11. aerosol substrate; 12. suction nozzle;
2. airflow heater;
21. susceptor; 211. air hole; 212. through hole; 213. magnetic inductor; 214. groove;
22. upper connecting sleeve; 221. first portion; 222. second portion; 223. first step structure; 224. protrusion; 225. airflow mixing cavity;
23. lower connecting sleeve; 231. third portion; 232. fourth portion; 233. second step structure; 234. notch;
24. temperature sensing component; 241. first thermocouple pole; 242. second thermocouple pole; 25. generator; 26. power supply assembly; 261. circuit control board;
271. inductor; 2711. sleeve body; 2712, shared wall; 272. electrode; 2721. pin; 273. resistive heating element;
28. temperature balancer;
3. compensation heater; and
4. connecting pipe.

### DETAILED DESCRIPTION

The following clearly and completely describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

The terms “first”, “second”, and “third” in this application are used for descriptive purposes only and should not be construed as indicating or implying relative importance or implicitly indicating the number of technical features indicated. All directionality indications (for example, up, down, left, right, front, and back) in the embodiments of this application are only used for explaining relative position relationships, movement situations or the like between various components in a specific posture (as shown in the accompanying drawings). If the specific posture changes, the directional indications change accordingly. In addition, terms “include”, “have”, and any variations thereof are intended to indicate non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

“Embodiment” mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

It should be noted that, when a component is referred to as “being fixed to” another component, the component may be directly on the other component, or an intervening component may be present. When a component is considered to be “connected to” another component, the component may be directly connected to the another component, or one or more intervening components may be present therebetween. The terms “vertical”, “horizontal”, “left”, “right”, and similar expressions used in this specification are only for purposes of illustration but not indicate a unique implementation.

An embodiment of this application provides an aerosol-generating device and a hybrid heating device used in an aerosol-generating device, configured to heat an aerosol substrate 11, to make the aerosol substrate 11 generate volatiles, and including an elongated cavity, an airflow heater 2, a compensation heater 3, and a connecting pipe 4.

The elongated cavity is configured to accommodate at least a part of the aerosol substrate 11.

The airflow heater 2 heats an airflow to generate a high-temperature airflow that can heat and evaporate the aerosol substrate 11, and then the high-temperature airflow enters the aerosol substrate, to heat the aerosol substrate 11 by using fluidity of the airflow. In this way, the aerosol substrate 11 can be heated evenly, an amount of aerosols formed by evaporation of the aerosol substrate 11 under baking of the high-temperature airflow can be increased, the waste of the aerosol substrate 11 can be reduced, and hazardous substances in the aerosol substrate 11 can be reduced.

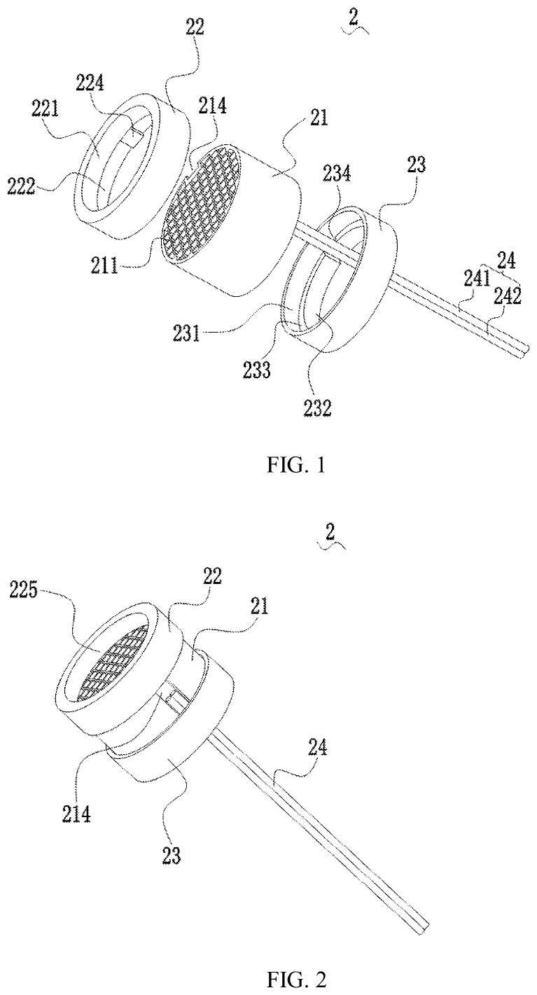

Referring to FIG. 1, the airflow heater 2 includes a susceptor 21.

The susceptor 21 may be a magnetic body. When an alternating magnetic field is applied to the magnetic body, an energy loss caused by an eddy current loss and a hysteresis loss occurs in the magnetic body.

The lost energy is released from the magnetic body as thermal energy. If an amplitude or a frequency of the alternating magnetic field applied to the magnetic body is greater, more heat energy can be released from the magnetic body.

In some embodiments, the susceptor 21 may include metal or carbon. The susceptor may include at least one of ferrite, a ferromagnetic alloy, stainless steel, or aluminum (AI). In addition, the susceptor may further include at least one of a ceramic such as graphite, molybdenum, silicon carbide, niobium, a nickel alloy, a metal film, or zirconia, a transition metal such as nickel (Ni) or cobalt (Go), and a metalloid such as boron (B) or phosphorus (P).

In some embodiments, referring to FIG. 1 to FIG. 10, the susceptor 21 may allow an airflow to pass through.

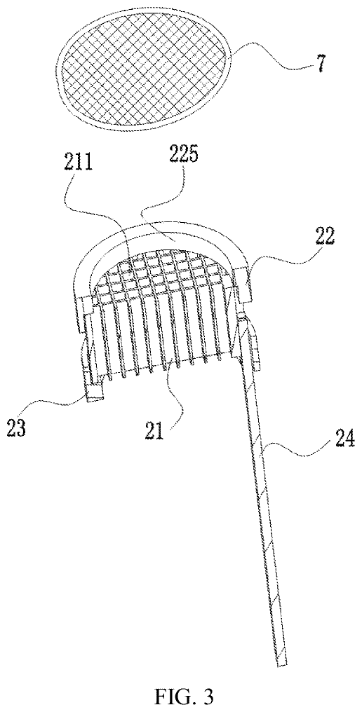

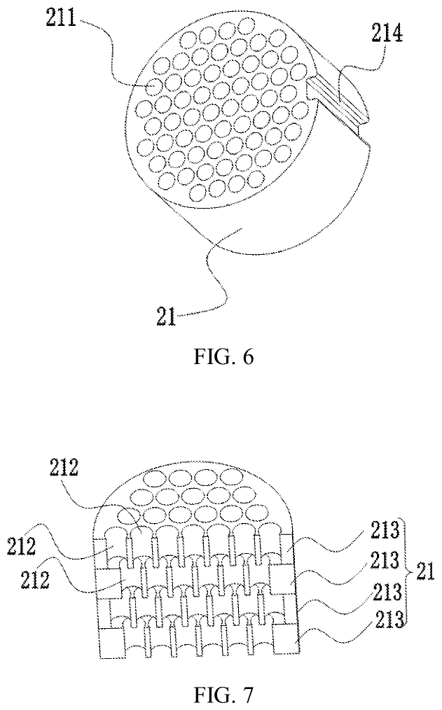

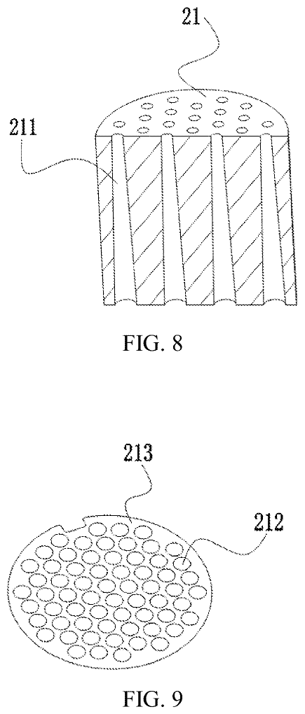

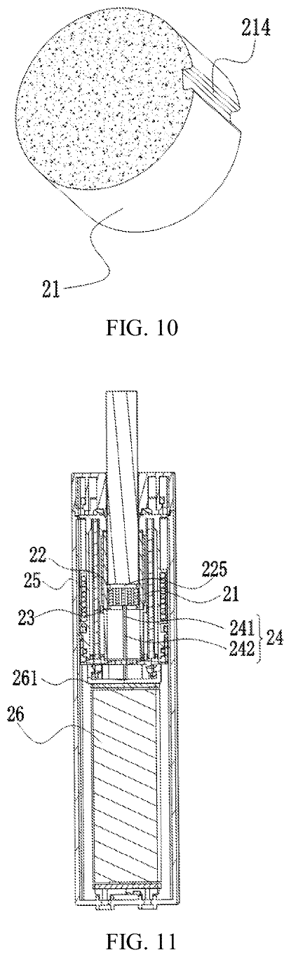

Referring to FIG. 3, FIG. 6, and FIG. 8, the susceptor 21 may have air paths for the airflow to pass through. These air paths may be regular air paths, and the airflow may flow into and out of the susceptor 21 along the air paths. Referring to FIG. 10, a material of the susceptor 21 has continuous pores inside with a microporous structure, and the airflow can pass through the pores, to flow in from one side of the susceptor 21, and flow out from the other side of the susceptor 21. In other embodiments, the susceptor may include both regular air paths and disordered pores. The airflow may pass through the air paths and the pores, to flow in from one side of the susceptor, and then flow out from the other side of the susceptor. When the susceptor generates heat in the alternating magnetic field, the airflow is heated by the susceptor in a flowing process in the susceptor.

The susceptor heats the airflow to generate the high-temperature airflow that can heat and evaporate the aerosol substrate 11. Therefore, the airflow flowing through the susceptor is heated more sufficiently and evenly by the susceptor, which is more helpful for the aerosol substrate 11 to be evaporated to generate a high-quality aerosol.

Referring to FIG. 1 to FIG. 3 and FIG. 6 to FIG. 8, in some embodiments, the susceptor 21 is set as a porous honeycomb structure. The airflow is divided into a plurality of streams, flows through a plurality of air paths on the honeycomb structure respectively, and exchanges heat with the susceptor 21 in the air paths, to be heated into the high-temperature airflow within a preset temperature range. Referring to FIG. 3 and FIG. 8, the susceptor in the honeycomb structure is provided with a large number of air holes 211. Each air hole 211 includes an air path for the airflow to pass through. A cross section of the air hole 211 may be a circle, a polygon, an ellipse, or the like. In this way, the airflow may be divided into a plurality of small air streams by the large number of air holes 211 on the susceptor 21, so that an entire heat exchange area of the airflow is increased, thereby ensuring that the entire airflow is rapidly and fully heated, and the entire airflow is evenly heated.

The susceptor 21 in the honeycomb structure can self-heat, and has a smaller heat capacity and a larger heat transfer rate than ceramic and glass, so that energy distribution at non-pore parts in the susceptor 21 is even, and there is no obvious temperature gradient in each part of the susceptor 21. Therefore, a plurality of small air streams passing through the air paths in the susceptor 21 can be heated to substantially the same temperature, so that the entire airflow is heated evenly. When the airflow with even heat throughout is used to enter a hot aerosol substrate carrier to contact the aerosol substrate, the aerosol substrate can also be heated more evenly, to generate a high-quality aerosol.

In some embodiments, the susceptor 21 is of a honeycomb structure made by using machining perforation, powder metallurgy, or MIN injection molding. The air holes 211 of the susceptor 21 may be straight air holes (as shown in FIG. 3 and FIG. 8). The air holes 211 of the susceptor 21 shown in FIG. 3 are square holes of a consistent size, and the air holes 211 of the susceptor 21 shown in FIG. 8 are tapered holes of inconsistent sizes. Specifically, referring to FIG. 6, the air holes 211 may alternatively be circular holes of a consistent size. A hole diameter of the circular hole may be 0.1 to 2 mm, for example, 0.6 mm, 1 mm, or 1.5 mm. A distance between two adjacent air holes 211 may be 0.1 to 0.5 mm, for example, 0.2 mm, or 0.4 mm. A height of the susceptor 21 may be 3 to 7 mm, for example, 3 mm, 5 mm, or 7 mm. An entire shape of the susceptor 21 may be a cylinder, and a diameter of a circular surface of the cylinder may be 5 to 9 mm, for example, 5 mm, 7 mm, or 9 mm. In some other embodiments, the entire shape of the susceptor 21 may alternatively be a polygonal body, an elliptical body, or the like.

In some embodiments, at least a part of the air paths in the susceptor 21 may be inclined air paths, inclined relative to a central axis of the susceptor 21, or at least a part of the air paths may be curved air paths. Both the inclined air path and the curved air path can increase a length of the air path, so that the time that the airflow is in the susceptor 21 is extended, to ensure that the airflow is fully heated.

In some embodiments, referring to FIG. 7 and FIG. 8, at least a part of the air paths in the susceptor 21 are irregular air paths. Each irregular air path has at least two parts of different sizes, that is, has a wide portion and a narrow portion. A cross-sectional area of the wide portion is greater than a cross-sectional area of the narrow portion, so that the narrow portion in the air path affects a flow rate or a flow velocity of the airflow, and even bounces part of the airflow, to retain the airflow for at least a short time, so that a heating time of the airflow in the susceptor 21 is extended, to cause the air flow to be fully heated. Referring to FIG. 8, the irregular air path may be a tapered air path. An upstream region of the tapered air path may have a larger width or cross-sectional area than a downstream region of the tapered air path, so that the air path in the tapered air path is narrowed, and therefore the time that the airflow is not in the air path can be extended, to extend the time that the airflow is retained in the susceptor 21, so that the airflow is fully and rapidly heated, and the entire airflow is heated evenly.

In some embodiments, referring to FIG. 10, the susceptor 21 is of a foam structure with continuous pores. The pores in the foam structure may be of different sizes. The pores in the foam structure may be alternately distributed in and out of the susceptor 21. The pores in the foam structure may have a rough surface. The rough surface may be uneven or have several micropores. These micropores may communicate with other pores. Several continuous pores in the porous material are connected to each other, so that the airflow flows from one side of the susceptor 21 to the other side. When passing through the susceptor 21 having the foam structure, the airflow can be in full contact with the susceptor 21, and has a very large heat exchange area, so that the airflow can be fully and rapidly heated by the susceptor 21, and the entire airflow is heated evenly. In some implementations, the velocity of the airflow passing through the susceptor 21 may be adjusted by adjusting an average hole diameter or porosity in a process of making the porous material.

Specifically, referring to FIG. 10, the susceptor 21 may be a honeycomb structure or a foam pipe structure prepared by using a sintering method after powder including a magnetic body is formed, and the powder including the magnetic body may be Fe—Ni powder, or the like, which is not limited herein.

In some embodiments, referring to FIG. 7, to facilitate control of the shape of the air path, the susceptor 21 may include a plurality of magnetic inductors 213. Each magnetic inductor 213 is provided with a plurality of through holes 212 for the airflow to pass through. The plurality of magnetic inductors 213 are stacked on each other, and corresponding through holes 212 of the magnetic inductors 213 communicate with each other, thereby forming the plurality of air paths on the susceptor 21. For example, when the through holes 212 of the magnetic inductors 213 in the susceptor 21 are in coaxial communication with each other, a straight air path may be formed; when the through holes 212 of some magnetic inductors 213 in the susceptor 21 are in staggered communication with each other, a curved air path may be formed; and when the magnetic inductors 213 in the susceptor 21 are in staggered communication with each other in the same direction, an inclined air path may be formed. In this way, the shape of the air path can be controlled based on a staggered status of the magnetic inductors 213 being stacked.

In some embodiments, referring to FIG. 9, the magnetic inductor 213 is a sheet structure with several through holes 212. The through holes 212 on the sheet structure may be formed by etching. A thickness of each magnetic inductor 213 may be 0.1 to 0.4 mm, for example, 0.1 mm, 0.25 mm, or 0.4 mm. The susceptor 21 may be formed by welding after 20 to 40 magnetic inductors 213 are stacked. Alternatively, referring to FIG. 7, the magnetic inductor 213 is of a block structure. The thickness of each magnetic inductor 213 may be 0.5 to 1.5 mm, for example, 0.5 mm, 1 mm, or 1.5 mm. The susceptor 21 may be formed by welding after 2 to 10 magnetic inductors 213 are stacked. In some other embodiments, each magnetic inductor 213 of the block structure may be formed by stacking a plurality of magnetic inductors 213 of the sheet structure.

Further, referring to FIG. 7, in the magnetic inductors 213 stacked on each other, all through holes 212 on the same air path are coaxial and have the same hole type and hole diameter, so that the formed air path has almost the same hole diameter throughout without an obvious wide portion or narrow portion, and the formed air path is a straight air path without bends.

Further, the same air path in the magnetic inductors 213 stacked on each other may have at least two mutually coaxial through holes. However, the two through holes may have different cross-sectional areas due to different hole types or hole diameters, so that the same air path has a wide portion and a narrow portion with different cross-sectional areas. Therefore, when the airflow flows along the air path, the narrow portion hinders the airflow, and retains the airflow for at least a short time to extend the time that the airflow is retained in the susceptor, so that the airflow is fully and rapidly heated, and the entire airflow is heated evenly.

Further, referring to FIG. 7, through holes 212 on the same air path in the magnetic inductors 213 stacked on each other may have different hole types or hole diameters, or may have the same hole type or hole diameter. However, at least two through holes 212 on the same air path in the magnetic inductors 213 stacked on each other are in staggered communication. After the through holes are in staggered communication, a local air path contracts, and a narrow portion is formed. Referring to FIG. 7, through holes 212 in two adjacent magnetic inductors 213 are locally staggered from each other in a one-to-one correspondence, so that each air path may have a cross-sectional area of a staggered position less than that of the through hole 212, that is, a narrow portion is formed at this position. Therefore, when the airflow enters a downstream through hole 212 from an upstream through hole 212, the air path is narrowed, so that the airflow is retained for at least a short time, to extend the time that the airflow is retained in the susceptor, so that the airflow is fully heated, and the entire airflow is heated evenly.

Further, referring to FIG. 7, there are at least two magnetic inductors 213 in the magnetic inductors 213 stacked on each other, and two the magnetic inductors 213 meet the following condition: At least one through hole 212 in the magnetic inductor 213 located upstream of the airflow can simultaneously communicate with at least two through holes 212 in a downstream magnetic inductor 213, so that the airflow in the upstream through hole 212 flows into the downstream magnetic inductor 213 in at least two streams. In other words, a distribution density of the through holes 212 in the upstream magnetic inductor 213 is less than that of the through holes 212 in the downstream magnetic inductor 213, or a distance between two adjacent through holes 212 in the downstream magnetic inductor 213 is less than the hole diameter of the through hole 212 in the downstream magnetic inductor 213, or the hole diameter of the through hole 212 in the upstream magnetic inductor 213 is several times the hole diameter of the through hole 212 in the upstream magnetic inductor 213, so that one through hole 212 in the upstream magnetic inductor 213 can simultaneously communicate with a plurality of through holes 212 in the downstream magnetic inductor 213. Therefore, when the airflow enters the downstream through hole 212 from the upstream through hole 212, the air path branches, and the airflow is re-divided into at least two streams. The narrow portion is located at the branch of the air path, so that the airflow can be retained for at least a short time, to extend the time that the airflow is retained in the susceptor, so that the airflow is fully and rapidly heated, and the entire airflow is heated evenly.

Further, in the same air path in the magnetic inductor 213 stacked on each other, at least one through hole 212 has a wide portion and a narrow portion, so that the air path has a wide portion and a narrow portion. An example shown in FIG. 8 may be a cross-sectional view of a magnetic inductor 213 in the susceptor 21. The through hole 212 in the magnetic inductor 213 may be a tapered hole, and a hole diameter in an upstream region is greater than that in a downstream region. In this way, the air path in the through hole is narrowed from wide, so that the airflow can be retained for at least a short time, to extend the time that the airflow is retained in the susceptor, so that the airflow is fully and rapidly heated, and the entire airflow is heated evenly.

To make the temperature of the airflow that heats the aerosol substrate more even, in some embodiments, referring to FIG. 1 to FIG. 4, the hybrid heating device further includes an airflow mixing cavity 225. The airflow mixing cavity 225 is located between the susceptor 21 and the aerosol substrate 11 or the aerosol substrate carrier, to mix the airflow flowing out of the air paths in the susceptor 21, and further balance the heat of the airflow flowing out of the air paths, so that the temperature of the airflow that heats the aerosol substrate 11 is more even.

Further, referring to FIG. 1 to FIG. 4, the hybrid heating device further includes an upper connecting sleeve 22 allowing the airflow to pass through. The upper connecting sleeve 22 is of a tubular structure, one end of the upper connecting sleeve 22 is connected to the susceptor 21, and the other end extends in a direction away from the susceptor 21 to be far away from the susceptor 21, and is a free end. The free end is used to support the aerosol substrate 11 or the aerosol substrate carrier. The airflow mixing cavity 225 may be located at an interval defined by the free end, the susceptor 21, and the upper connecting sleeve 22. The airflow flowing out of the susceptor 21 first enters the airflow mixing cavity 225, and balances the heat in the airflow mixing cavity 225. Because the temperature of the airflow gradually decreases when the airflow exchanges heat with the aerosol substrate 11, as the airflow flows in the aerosol substrate, the temperature of the airflow gradually decreases. Therefore, the airflow just flowing out of the susceptor 21 has the highest the temperature. Because the airflow mixing cavity 225 is located between the aerosol substrate 11 or the aerosol substrate carrier and the susceptor 21, the aerosol substrate 11 or the aerosol substrate carrier may alternatively be spaced apart from the susceptor 21, so that the aerosol substrate 11 (for example, cigarette 1) can be prevented from being burnt due to direct contact with the susceptor 21 in a high-temperature and heating state and the high-temperature airflow just flowing out of the susceptor 21.

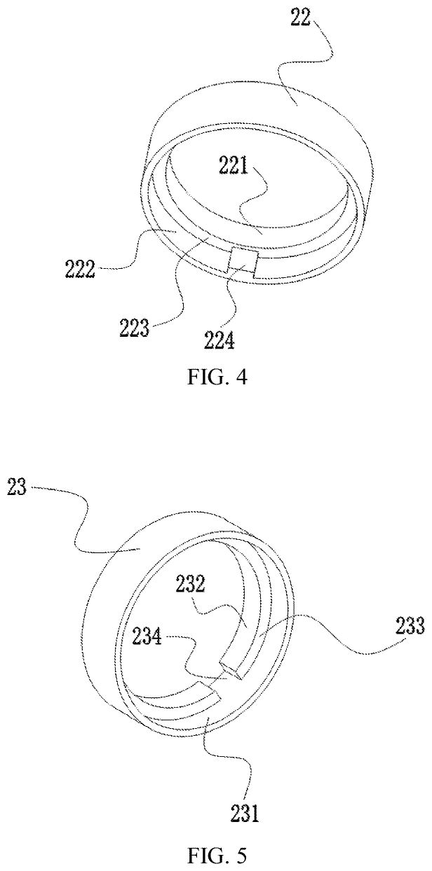

Further, referring to FIG. 4, the upper connecting sleeve 22 includes a first portion 221 and a second portion 222. The first portion 221 and the second portion 222 may be coaxial. The airflow mixing cavity 225 is located in the first portion 221. The second portion 222 is sleeved on a side surface of the susceptor 21. An inner diameter of the first portion 221 is less than that of the second portion 222, so that an inner wall of the upper connecting sleeve 22 has a first step structure 223, and an upper end of the susceptor 21 may abut against the first step structure 223. An outer diameter of the first portion 221 may be equal to that of the second portion 222, and a wall thickness of the first portion 221 is greater than that of the second portion 222, so that the free end of the upper connecting sleeve 22 has a large annular area (supporting area), to better support the aerosol substrate or the aerosol substrate carrier.

Optionally, the upper connecting sleeve 22 may be formed by using an insulating material with a low thermal conductivity, such as zirconia ceramic or high-temperature resistant plastic such as PBI (the low thermal conductivity in this application is a thermal conductivity less than that of metal), to slow a temperature loss rate in the airflow mixing cavity 225. Further, a thermal insulation layer may be arranged out of or in at least a partial region of the upper connecting sleeve 22 to reduce heat transfer outward.

In an embodiment, as shown in FIG. 3, the aerosol-generating device further includes a baffle mesh 7. The baffle mesh 7 is located between the aerosol substrate 11 and the susceptor 21 in a flowing direction of the airflow. The baffle mesh 7 has a large number of holes for the airflow to pass through, so that air heated by the susceptor 21 can pass through and then flow into the aerosol substrate 11 located downstream of the baffle mesh 7 in an airflow direction. The baked aerosol substrate 11 usually becomes brittle. During removal of the aerosol substrate 11 from a container 6, if the aerosol substrate 11 is crushed or broken to result in drops such as sediments, debris, or residues, the drops fall on the baffle mesh 7. In other words, the baffle mesh 7 can prevent the susceptor 21 from being blocked by sediments, debris, or residues of the aerosol substrate 11 falling on the susceptor 21.

In an optional embodiment, the baffle mesh 7 may be arranged downstream of the upper connecting sleeve 22 and spaced apart from the upper connecting sleeve 22, so that the drops such as sediments, debris, or residues of the aerosol substrate 11 do not fall into the upper connecting sleeve 22. In another optional embodiment, the baffle mesh 7 may be arranged on the upper connecting sleeve 22 and is in contact with the free end of the upper connecting sleeve 22, so that the drops such as sediments, debris, or residues of the aerosol substrate 11 do not fall into the upper connecting sleeve 22. In still another optional embodiment, the baffle mesh 7 may be arranged inside the upper connecting sleeve 22. In other optional embodiments, the baffle mesh 7 may be arranged in the container 6 and is detachably connected to the container 6, so that the baffle mesh 7 may be removed to clean out the drops such as sediments, debris, or residues on the baffle mesh 7 and prevent the baffle mesh 7 from being blocked.

In an optional embodiment, the baffle mesh 7 may replace the upper connecting sleeve 22 to support the aerosol substrate 11 or the aerosol substrate carrier, that is, the baffle mesh 7 is used for replacing the upper connecting sleeve 22. Therefore, in this embodiment, the baffle mesh 7 can support the aerosol substrate 11 or the aerosol substrate carrier, isolate the susceptor 21 from the aerosol substrate or enable an air space between the susceptor 21 and the aerosol substrate, and can further carry the drops such as sediments, debris, or residues from the aerosol substrate 11, to prevent the drops from blocking the susceptor 21.

To enable the baffle mesh 7 to well block the drops such as sediments, debris, or residues of the aerosol substrate 11, mesh holes on the baffle mesh 7 have a small hole diameter. In some embodiments, the hole diameter of the holes on the baffle mesh 7 may be less than a hole diameter in the air path in the susceptor 21. In some embodiments, the baffle mesh 7 is constructed into a mesh structure, having a large number of evenly distributed mesh holes.

Further, referring to FIG. 1 to FIG. 3 and FIG. 5, the hybrid heating device further includes a lower connecting sleeve 23 allowing the airflow to pass through. The lower connecting sleeve 23 is of a tubular structure, one end of the lower connecting sleeve 23 is connected to the susceptor 21, and the other end extends in a direction away from the susceptor 21 to be far away from the susceptor 21, and is a free end. The free end is an anti-collision end, and is used to protect the susceptor 21 to prevent the susceptor 21 from being hit.

Optionally, the lower connecting sleeve 23 may be made of an insulating material with a low thermal conductivity, for example, zirconia ceramic or high-temperature resistant plastic such as PBI, to reduce heat transfer outward from the susceptor 21, avoid energy waste, and improve energy utilization. Generally, the thermal conductivity of the lower connecting sleeve 23 is higher than that of air. Therefore, a size of the lower connecting sleeve 23 may be designed as small as possible. Preferably, the lower connecting sleeve 23 and the upper connecting sleeve 22 are spaced apart and are not in contact with each other.

Optionally, referring to FIG. 5, the lower connecting sleeve 23 includes a third portion 231 and a fourth portion 232. The third portion 231 and the fourth portion 232 may be coaxial. The third portion 231 is sleeved on a local side surface of the susceptor 21. The fourth portion 232 is located outside the susceptor 21. An inner diameter of the third portion 231 is less than that of the fourth portion 232, so that an inner wall of the lower connecting sleeve 23 has a second step structure 233, and a lower end of the susceptor 21 may be supported by the second step structure 233. An outer diameter of the third portion 231 may be equal to that of the fourth portion 232, and a wall thickness of the fourth portion 232 is greater than that of the third portion 231, so that the susceptor 21 can be better protected from being hit.

Referring to FIG. 2, the susceptor 21 may be fixed in the connecting pipe 4 by using the upper connecting sleeve 22 and the lower connecting sleeve 23, thereby becoming a part of the aerosol-generating device.

In some embodiments, referring to FIG. 1 to FIG. 3, the hybrid heating device further includes a temperature sensing component 24. The temperature sensing component 24 is connected to the susceptor 21, and is configured to detect a temperature of the susceptor 21, or is configured to check the temperature of the susceptor 21 together with the susceptor 21.

In some embodiments, the temperature sensing component 24 may be a thermocouple pole. The thermocouple pole includes a hot end and a cold end. The hot end is a temperature detection end connected to a measured object to sense a temperature of the measured object. The cold end is generally a control end with a known temperature. The thermocouple pole generates a thermo-electromotive force under a temperature difference. A larger temperature difference indicates a that a larger thermo-electromotive force is generated. In this way, a temperature difference signal of a thermocouple may be obtained by checking the thermo-electromotive force of the thermocouple pole, so that the temperature of the measured object may be detected by using the thermocouple pole.

A material of the susceptor determines that the susceptor is an electrical conductor. In some embodiments of this application, when the thermocouple pole and the susceptor are electrically connected to each other, the thermocouple pole and the susceptor form a thermocouple, and the susceptor forms a temperature detection end of the thermocouple.

Specifically, referring to FIG. 1 to FIG. 3, the thermocouple pole includes a first thermocouple pole 241 and a second thermocouple pole 242. A first thermocouple electrode 31 and a second thermocouple electrode 32 are made of different metals or alloys. For example, the first thermocouple electrode 31 is made of a nickel-chromium alloy, and the second thermocouple electrode 32 is made of a nickel-silicon alloy; or the first thermocouple electrode 31 is made of copper, and the second thermocouple electrode 32 is made of a copper-nickel alloy; or, the first thermocouple electrode 31 is made of iron, and the second thermocouple electrode 32 is made of a copper-nickel alloy; or the first thermocouple electrode 31 and the second thermocouple electrode 32 are S, B, E, K, R, J, or T type thermocouple wires. A first end of the first thermocouple electrode 31 and a first end of the second thermocouple electrode 32 are both electrically connected to the susceptor 21, so that the first end of the first thermocouple electrode 31 and the second thermocouple electrode 32 can be electrically connected through the susceptor 21. A second end of the first thermocouple electrode 31 and a second end of the second thermocouple electrode 32 are both electrically connected to a detection module. The detection module is electrically connected to the power supply assembly. The power supply assembly can indirectly supply power to the thermocouple, to form a temperature detection loop. When used as a heating element, a susceptor 1 also forms the temperature detection end of the thermocouple, so that the heating temperature of the susceptor 1 can be detected more accurately. In addition, energy of heating of the susceptor 1 is from the alternating magnetic field. Although the susceptor 1 is electrically connected to the first thermocouple electrode 31 and the second thermocouple electrode 32, the susceptor 1 does not obtain electricity from the first thermocouple electrode 31 and the second thermocouple electrode 32 to generate heat. The susceptor 1 generates an eddy current in the alternating magnetic field. To prevent the eddy current from affecting temperature detection, when the eddy current appears in the susceptor 1, the power supply assembly does not supply power to the first thermocouple electrode 31 and the second thermocouple electrode 32. When the eddy current disappears in the susceptor 1, the power supply assembly supplies power to the first thermocouple electrode 31 and the second thermocouple electrode 32, to detect the temperature of the susceptor 1.

Referring to FIG. 1 to FIG. 4, the first thermocouple pole 241 and the second thermocouple pole 242 are arranged in parallel. A groove 241 is provided on a side surface of the susceptor 21 to accommodate end portions of the first thermocouple pole 241 and the second thermocouple pole 242. The groove 214 protects the end portions of the first thermocouple pole 241 and the second thermocouple pole 242, and joints between the first thermocouple pole 241 and the susceptor 21 and between the second thermocouple pole 242 and the susceptor 21 and the susceptor 21, to prevent the susceptor 21 from wearing the first thermocouple pole 241 and the second thermocouple pole 242 during assembly with another element and avoid affecting contact stability between the joints and the susceptor 21. The groove 214 can communicate an upper surface and a lower surface of the susceptor 21. To prevent the airflow from passing through the groove 214, a protrusion 224 is provided at a position corresponding to the groove 214 on the upper connecting sleeve 22, and the protrusion 224 may be embedded in the groove 214, to block the airflow. Referring to FIG. 4, the protrusion 224 is provided on an inner wall of the second portion 222 of the upper connecting sleeve 22. A thickness of the protrusion 224 may be less than the wall thickness of the first portion 221. A width of the first step structure 223 in the upper connecting sleeve 22 may be greater than the thickness of the protrusion 224.

Referring to FIG. 1 to FIG. 3 and FIG. 5, a notch 234 is provided on the fourth portion 232 of the lower connecting sleeve 23. The notch 234 is provided corresponding to the first thermocouple pole 241 and the second thermocouple pole 242. The first thermocouple pole 241 and the second thermocouple pole 242 are electrically connected to the detection module after running through the notch 234.

In an embodiment as shown in FIG. 11, an aerosol-generating device and a hybrid heating device used in an aerosol-generating device further include a power supply assembly 26, a magnetic field generator 25 configured to generate an alternating magnetic field, and the hybrid heating device.

The magnetic field generator 25 may be a sleeve-shaped coil surrounding outside the side surface of the susceptor 21. In some other embodiments, the generator 25 may alternatively be of a flat structure, located on one side, such as an upper, a lower, a front, a rear, a left, or a right side, of the susceptor. The power supply assembly is electrically connected to the magnetic field generator 25 to supply power to the alternating magnetic field generated by the magnetic field generator 25.

The power supply assembly 26 is electrically connected to the thermocouple pole, to supply power for detecting the temperature of the susceptor 21. Specifically, referring to FIG. 11, the power supply assembly 26 is electrically connected to the first thermocouple pole 241 and the second thermocouple pole 242. The power supply assembly 26, the first thermocouple pole 241, the second thermocouple pole 242, and the susceptor 21 may form a power supply loop. The power supply assembly 26 includes a circuit control board 261, and the power supply assembly 26 is electrically connected to the magnetic field generator 25, the first thermocouple pole 241, and the second thermocouple pole 242 through the circuit control board 261. Under the control of the circuit control board 261, the power supply assembly 26 alternately supplies power to the first thermocouple pole 241, the second thermocouple pole 242, and the magnetic field generator 25, to cause the first thermocouple pole 241, the second thermocouple pole 242, and the magnetic field generator 25 to alternately operate.

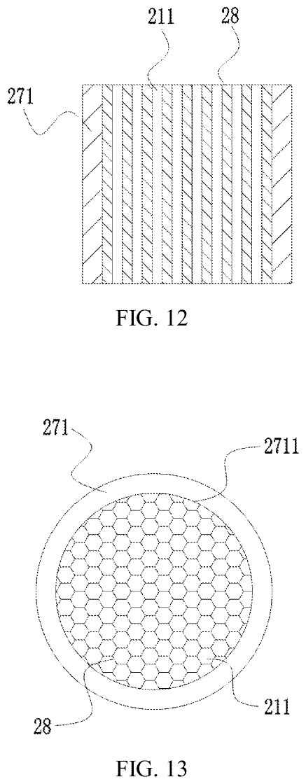

Referring to FIG. 12, the airflow heater 2 in an embodiment of this application includes an inductor 271, a temperature balancer 28, and at least two air holes 211.

In some embodiments, the temperature balancer may be made of a ceramic. Further, the ceramic may be made of a honeycomb ceramic. The honeycomb ceramic has a porous structure, that is, a large number of air holes are distributed in the honeycomb ceramic, to bring about a larger surface area for heat exchange, so that the airflow heater has high efficiency of heating air. Moreover, the honeycomb ceramic of the porous structure is closer to a solid structure, and has a higher heat capacity than a ceramic pipe of the same volume. In addition, a thermal conductivity of aluminum oxide is larger than 30 W/MK, so that heat can be conducted more evenly and rapidly. With the high thermal conductivity, the honeycomb ceramic of the porous structure can meet a requirement of rapidly heating the air to a preset temperature.

In some embodiments, the temperature balancer may be made of an aluminum oxide ceramic, an aluminum nitride ceramic, a silicon nitride ceramic, a silicon carbide ceramic, a beryllium oxide ceramic, a zirconia ceramic, or the like. The air holes on the honeycomb ceramic may be circle holes, elliptical holes, and polygonal holes, and the polygonal holes include triangular holes, square holes, hexagonal holes, and the like.

Referring to FIG. 12 to FIG. 15, the temperature balancer 28 is connected to the inductor 271, so that the temperature balancer 28 can exchange heat with the inductor 271.

The inductor may be a magnetic body. When an alternating magnetic field is applied to the magnetic body, an energy loss caused by an eddy current loss and a hysteresis loss occurs in the magnetic body. The lost energy is released from the magnetic body as thermal energy. If an amplitude or a frequency of the alternating magnetic field applied to the magnetic body is greater, more heat energy can be released from the magnetic body.

In some embodiments, referring to FIG. 12 and FIG. 13, the inductor 271 may be a sleeve structure or a ring structure having a sleeve body 2711. The sleeve body 2711 is hollow and open at upper and lower ends. In the alternating magnetic field, a sleeve wall of the sleeve body 2711 generates an eddy current and has magnetic hysteresis, to cause the sleeve body 2711 to generate heat. If no temperature balancer is arranged in the sleeve body, a temperature gradient is formed between the sleeve wall and a sleeve center of the sleeve body, resulting in uneven heat distribution in the inductor, which may lead to uneven heating of the airflow heated by the inductor.

To overcome the above problem, referring to FIG. 12 and FIG. 13, the inductor 271 has a temperature balancer 28. The temperature balancer 28 is located inside the inductor 271, and may be in contact with an inner wall of the susceptor 21 to exchange heat with the inductor 271 at a higher efficiency. The temperature balancer 28 has a higher thermal conductivity than air, and can quickly absorb the heat of the inductor 271, and the heat can be quickly balanced on the temperature balancer 28. In this way, the temperature gradient of the sleeve body 2711 from the sleeve wall to the sleeve center is reduced, so that the heat distribution in the inductor 271 is even to balance the temperature in each air hole 211.

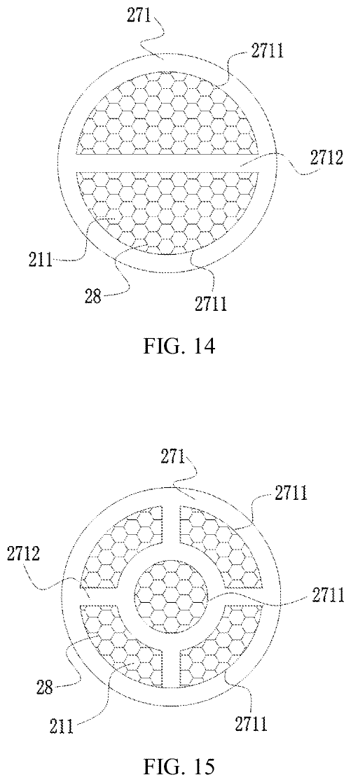

In some embodiments, referring to FIG. 14 and FIG. 15, the inductor may be a sleeve structure or a ring structure having at least two sleeve bodies 2711. A shared wall 2712 is arranged between two adjacent sleeve bodies 2711. The shared wall 2712 may also generate heat in the alternating magnetic field. The shared wall 2712 divides an internal space of the inductor 271 into at least two parts, so that at least two sleeve bodies 2711 may be formed in the susceptor 21. The shared wall 2712 enables an interior of the susceptor 21 to generate heat, so that a temperature gradient from an outer side wall to a center of the inductor 271 can be reduced. Because the susceptor 21 is divided into a plurality of sleeve bodies 2711 of small volume by the shared wall 2712, a distance between a sleeve wall of each sleeve body 2711 and a center of the sleeve body can be reduced, and the temperature gradient from the sleeve wall of each sleeve body 2711 to the center of the sleeve body can be further reduced.

The sleeve body 2711 may extend in the flowing direction of the airflow. The sleeve body 2711 may be of a straight structure, a bent structure, or an inclined structure.

In some embodiments, referring to FIG. 12 to FIG. 15, the temperature balancer 28 may be arranged in each sleeve body 2711 of the inductor 271 to increase a total heat exchange area of the temperature balancer 28 with the susceptor 21, so that heat exchange efficiency and heat balancing efficiency are improved. In this case, at least some of the air holes 211 may be located on the temperature balancer 28. For example, the temperature balancer 28 is set to a honeycomb ceramic. At least some of the air holes 211 may alternatively be located in a gap between the inductor 271 and the temperature balancer 28. For example, the temperature balancer 28 is in surface contact, line contact, or point contact with the corresponding sleeve body 2711. An outer side wall of the temperature balancer 28 or an inner side wall of the sleeve body 2711 may be set to a wave surface, a threaded surface, a staggered dotted surface, or the like.

In some embodiments, referring to FIG. 15, the inductor 271 is set to a honeycomb structure having a plurality of sleeve bodies 2711. The temperature balancer may be arranged in some of the sleeve bodies, and the temperature balancer may not be arranged in some of the sleeve bodies, so that the sleeve bodies without the temperature balancer may be the air holes, allowing the airflow to pass through. Optionally, each temperature balancer is provided with at least one air hole. A hole diameter of the air hole on the temperature balancer may be the same as a sleeve diameter of the sleeve body used as the air hole. The temperature balancers are evenly distributed in the susceptor to balance the temperature throughout the interior of the susceptor as much as possible.

In some embodiments, referring to FIG. 12, the temperature balancer 28 is in surface contact with the corresponding sleeve body 2711, and the outer side wall of the temperature balancer 28 abuts the inner wall of the corresponding sleeve body 2711 to increase the heat exchange area.

In some embodiments, a heat capacity of the temperature balancer is greater than that of the inductor, so that after each puff of airflow, for example, 50 ml of air, passes through a non-contact heater, the non-contact heater has a small temperature drop of only 20° C. to 30° C. or even less at the heat capacity of the temperature balancer.

In some embodiments, not shown in the figures, a plurality of heating elements are provided. Each heating element forms a sheet or plate surface heat source, and each temperature balancer is located between two heating elements, to form a sandwich structure. An extending direction of the plurality of heating elements and the temperature balancer may be consistent with a traveling direction of the air. In other words, the plurality of heating elements and the temperature balancer are stacked in a transverse direction to form one or more sandwich structures. The air hole may be provided in the heating element, or provided in the temperature balancer, or defined between the heating element and the temperature balancer. In some other embodiments, not shown in the figures, the extending direction of the plurality of heating elements and the temperature balancer may be perpendicular to the traveling direction of the air. In other words, the plurality of heating elements and the temperature balancer are stacked in a radial direction to form one or more sandwich structures. A channel is provided on both the heating elements and the temperature balancer, and the channels on the heating elements and the temperature balancer are in facing or staggered communication to form air holes for the air to pass through. The channels on the heating elements and the temperature balancer may have the same hole diameter or different hole diameters, may have the same hole shape or different hole shapes, and may have the same channel distribution density or different channel distribution density. The air needs to pass through the heating elements and the temperature balancer one by one, to be heated to form heated air that meets a preset requirement.

In some embodiments, the susceptor and the temperature balancer are in a shape of a rod or a sheet. The susceptor and the temperature balancer are staggered. The air holes are distributed between the heating elements and the temperature balancer, or distributed on the temperature balancer, or distributed on the susceptor.

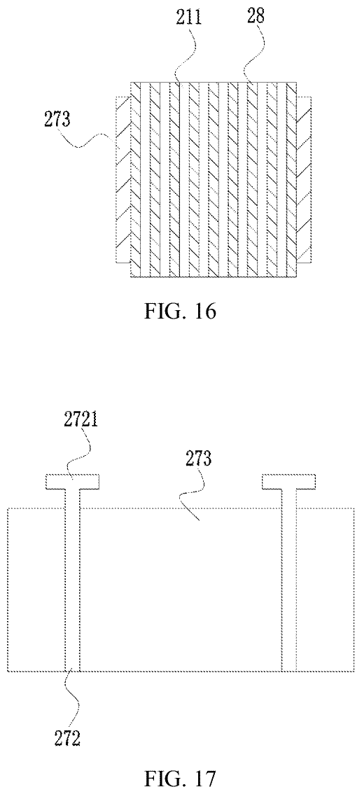

Referring to FIG. 16, the airflow heater 2 in an embodiment of this application includes a resistive heating element 273, a temperature balancer, and at least two air holes.

In some embodiments, referring to FIG. 16 to FIG. 18, the resistive heating element 273 is a resistive film, a mesh, a resistive wire, or a resistive sheet. Correspondingly, the temperature balancer 28 may be made of a honeycomb ceramic, and the resistive heating element 273 covers the outer side wall of the temperature balancer 28, and abuts the outer side wall of the temperature balancer 28, to reduce thermal resistance of a heat transfer process.

The resistive heating element 273 may be arranged at least on the outer side wall of the temperature balancer 28 through a thick film printing process, a physical vapor deposition process, a chemical vapor deposition process, a spraying process, or the like.

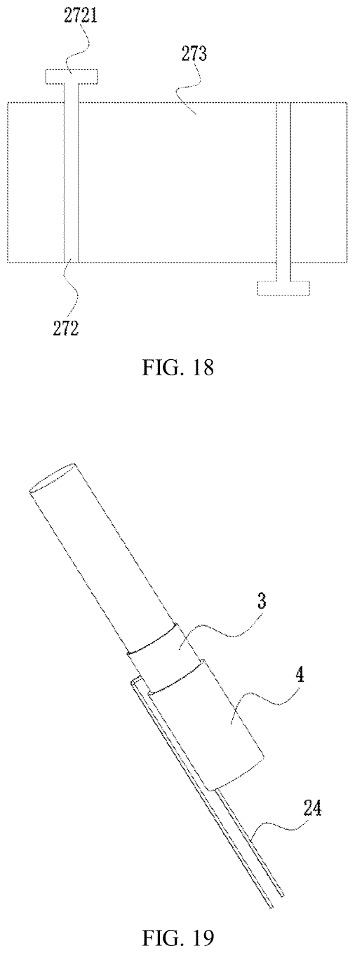

Further, referring to FIG. 16 to FIG. 18, the airflow heater 2 further includes an electrode 272. The electrode 272 is electrically connected to the resistive heating element 273. The electrode 272 may be arranged on the outer side wall of the temperature balancer 28 through the thick film printing process, the physical vapor deposition process, the chemical vapor deposition process, the spraying process, or the like. Then the resistive heating element 273 may be prepared through the thick film printing process, the physical vapor deposition process, the chemical vapor deposition process, the spraying process, or the like. The resistive heating element 273 is arranged at least on the outer side wall of the temperature balancer 28. A part of the electrode 272 overlaps the resistive heating element 273, and a part of the electrode 272 is exposed outside of the resistive heating element 273, forming a pin 2721 of the electrode 272 to be electrically connected to other conductors. Two electrodes 272, respectively a positive electrode and a negative electrode, are provided. The pins 2721 of the positive and negative electrodes may be located on the same side of the resistive heating element 273, as shown in FIG. 17, or may be located on two opposite sides of the resistive heating element 273, as shown in FIG. 18.

Optionally, the resistive heating element may be a mosquito-coil resistor or a mesh resistor, so that the airflow can pass through the resistive heating element. Several air holes allowing the airflow to pass through are provided in the temperature balancer. The resistive heating element and the temperature balancer may be stacked and staggered in the traveling direction of the airflow, so that before heating the aerosol substrate, the airflow needs to pass through the resistive heating element and the temperature balancer one by one. The resistive heating element and the temperature balancer may be stacked and staggered in the traveling direction of the airflow, so that the resistive heating element heats the temperature balancer from above or below or from both above and below of the temperature balancer. Then the temperature balancer absorbs heat, stores heat, releases heat, and the like, to balance the temperature of the air holes in the temperature balancer.

When an axial length of the aerosol substrate is large, because an upstream section of the aerosol substrate is close to the airflow heater, a bottom of the aerosol substrate can be substantially heated sufficiently by the high-temperature airflow. A downstream section of the aerosol substrate is far away from the airflow heater, so that when the high-temperature airflow flows to the downstream section of the aerosol substrate, the downstream section of the aerosol substrate cannot be sufficiently baked due to the temperature drop, resulting in a small amount of aerosols generated by the aerosol substrate and a large waste of aerosol substrate. If the temperature of the airflow is increased by increasing a heating power of the airflow heater, the upstream section of the aerosol substrate is burnt, affecting the taste.

To resolve the problem of uneven heating of the upstream and downstream sections of the aerosol substrate under airflow heating, a compensation heater 3 is added in an embodiment of this application, to compensate for insufficiency of the airflow heated by the airflow heater.

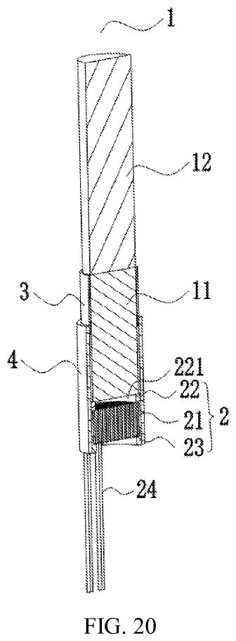

In some embodiments, referring to FIG. 19 and FIG. 20, the compensation heater 3 includes at least one heating element. The heating element is arranged coaxially with the aerosol substrate 11, and is arranged at a periphery of a section outside of the upstream section of the aerosol substrate 11, to heat the aerosol substrate 11 of the section. The upstream section of the aerosol substrate 11 is the section of the aerosol substrate 11 on which a sufficient amount of volatiles can be baked out by the airflow heated by the airflow heater 2.

In some embodiments, referring to FIG. 19 and FIG. 20, the compensation heater 3 is a circumferential heater. Heat emitted by the compensation heater 3 is transferred from a surface of the aerosol substrate 11 to a center of the aerosol substrate 11, so that the aerosol substrate 11 can be heated from outside. Correspondingly, the heating element may include an annular body. The annular body may be of a closed loop structure or an open loop structure, may be formed by curling a single heating plate, or may be enclosed by a plurality of heating plates annularly distributed, where the plurality of heating plates may be interconnected, or spaced apart from each other.

In some embodiments, referring to FIG. 19 and FIG. 20, only one heating element is provided, and is arranged at the periphery of the section outside of the upstream section of the aerosol substrate 11, to heat the aerosol substrate 11 that cannot be baked or is not fully baked by the airflow heated by the airflow heater 2.

Optionally, a heating power of the compensation heater is adjustable. When there is an inhalation action, the compensation heater may generate heat prior to the airflow heater, or may generate heat synchronously with the airflow heater. However, the compensation heater may have a large heating power in this case, so that at least the downstream section of the aerosol substrate can rapidly generate aerosol volatiles for smoking, to meet a requirement for rapid smoke generation. Later, the compensation heater may reduce the heating power properly to heat the aerosol substrate of the corresponding section. However, the generated heat is insufficient to evaporate the aerosol substrate. An objective is to maintain the temperature of the aerosol substrate of the corresponding section within a preset temperature range, preventing the temperature of the high-temperature airflow heated by the airflow heater from falling rapidly when flowing from the upstream section to the downstream section, or reduce a drop rate of the temperature of the high-temperature airflow heated by the airflow heater, to ensure that the high-temperature airflow heated by the airflow heater has a sufficient temperature throughout the aerosol substrate to bake out a sufficient amount of aerosols from the aerosol substrate. In this way, the aerosol volatiles are mainly generated by baking the aerosol substrate that is in contact with the high-temperature airflow using the high-temperature airflow. The fluidity of the airflow is used for ensuring the aerosol substrate to be evenly heated throughout, thereby reducing the waste of the aerosol substrate, and improving the taste.

Optionally, the heating power of the compensation heater is fixed, and the heating power of the compensation heater after stable operation generates heat that may always cause the aerosol substrate of the corresponding section to generate the aerosol volatiles, to avoid the waste of the aerosol substrate that cannot be indirectly heated by the airflow heater using the airflow, and increase an amount of aerosols generated per unit time and improve the taste.

Optionally, the heating power of the compensation heater is fixed, and the heating power of the compensation heater after stable operation generates heat that always cannot cause the aerosol substrate of the corresponding section to generate the aerosol volatiles. The heat generated is mainly used to preheat the aerosol substrate of the corresponding section, or is used to maintain the temperature of the aerosol substrate of the corresponding section within a preset temperature range, to prevent the airflow heated by the airflow heater from decreasing in the section outside of the upstream section of the aerosol substrate, and losing a capability of making the aerosol substrate evaporate a sufficient amount of aerosol volatiles, so that the aerosol volatiles are mainly generated by the high-temperature airflow baking the aerosol substrate that is in contact with the high-temperature airflow.

In some other embodiments, two, three, or more heating elements are provided, and are arranged at the periphery of the section outside of the upstream section of the aerosol substrate, to heat in segments the aerosol substrate that cannot be baked by the airflow heated by the airflow heater.

Optionally, some of the heating elements are arranged corresponding to the downstream section of the aerosol substrate to heat the aerosol substrate of the downstream section, and some of the heating elements are arranged corresponding to a midstream section of the aerosol substrate to heat the aerosol substrate of the midstream section. Different heating elements may have different heating powers, or heating elements arranged corresponding to different sections of the aerosol substrate may have different heating powers, so that each heating element may be individually controlled, or at least some of the heating elements arranged corresponding to the same section of the aerosol substrate may be synchronously controlled.

Specifically, the heating power of the heating element arranged corresponding to the downstream section of the aerosol substrate may be greater than that of the heating element arranged corresponding to the midstream section of the aerosol substrate, and the heating element arranged corresponding to the downstream section of the aerosol substrate may operate only during a pre-stage of inhalation for rapid smoke generation. The heating element arranged corresponding to the midstream section of the aerosol substrate may operate throughout the inhalation, mainly for preheating the aerosol substrate of the corresponding section and maintaining the temperature of the aerosol substrate of the corresponding section within a preset range. Due to the heating element arranged corresponding to the midstream section of the aerosol substrate, the airflow heated by the airflow heater loses less heat when passing through the midstream section. If the downstream section of the aerosol substrate is short enough, the airflow still has a high temperature when the airflow enters the downstream section, so that the aerosol volatiles in the downstream section of the aerosol substrate can be baked out, to save energy and fully use of the heat of the airflow.

Optionally, the heating power of the heating element arranged corresponding to the midstream section of the aerosol substrate may be greater than or equal to that of the heating element arranged corresponding to the midstream section of the aerosol substrate. The heating element arranged corresponding to the midstream section of the aerosol substrate may operate intermittently, to maintain the temperature of the aerosol substrate of the corresponding section within a preset range.

In some embodiments, referring to FIG. 19 and FIG. 20, the compensation heater 3 includes a heat conductive pipe and a heating member. The heat conductive pipe is an annular body arranged at the periphery of the aerosol substrate 11, and the heating member is arranged on the heat conductive pipe. The heat conductive pipe may be made of a material having good heat conduction and heat balancing properties, such as ceramic, quartz, or metal having an insulating layer. The heating member may be a resistive film, a mesh, a resistive wire, or a resistive sheet attached to the heat conductive pipe, the heating member may generate heat when powered on, and the heat conductive pipe can absorb and transfer the heat generated by the heating member.

In some embodiments, referring to FIG. 19 and FIG. 20, the compensation heater 3 includes an inductive heating pipe. The inductive heating pipe can generate heat in the alternating magnetic field. The inductive heating pipe is arranged at the periphery of the aerosol substrate 11.

The compensation heater further includes a coil for generating the alternating magnetic field. The coil is located at a periphery of the inductive heating pipe. The inductive heating pipe induces the coil to generate an eddy current loss and a hysteresis loss, thereby generating heat to heat the corresponding aerosol substrate.

In some embodiments, referring to FIG. 19 and FIG. 20, the connecting pipe 4 is a tubular body. The airflow heater 2 is located in the connecting pipe 4. The susceptor 21 is in contact with an inner wall of the connecting pipe 4 through the upper connecting sleeve 22 and the lower connecting sleeve 23, and a spacing is provided between the side surface of the susceptor 21 and the inner wall of the connecting pipe 4.

In some embodiments, referring to FIG. 19 and FIG. 20, the connecting pipe 4 may accommodate at least the upstream section of the aerosol substrate 11. In the connecting pipe 4, a considerable spacing may be provided between the aerosol substrate 11 and the airflow heater 2. To save space and reduce volume, the aerosol substrate 11 may be supported by the upper connecting sleeve 22 in the connecting pipe 4, so that a spacing is provided between the aerosol substrate 11 and the susceptor 21, to prevent the susceptor 21 and the airflow that just leaves the susceptor 21 from burning the aerosol substrate 11.

In some embodiments, referring to FIG. 19 and FIG. 20, the compensation heater 3 is connected to the connecting pipe 4. A part of the aerosol substrate 11 is located in the connecting pipe 4, and the other part of the aerosol substrate 11 is located in the compensation heater 3.

Optionally, referring to FIG. 19 and FIG. 20, a part of the compensation heater 3 extends into the connecting pipe 4, and the other part of the compensation heater 3 is located outside the connecting pipe 4. A thickness of the compensation heater 3 is less than that of the connecting pipe 4, to reduce a difference between inner diameters of the connecting pipe 4 and the compensation heater 3.

Optionally, referring to FIG. 19 and FIG. 20, the airflow heater 2 has a large heating effect, so that an axial length of the aerosol substrate 11 located in the compensation heater 3 is less than that of the aerosol substrate 11 not accommodated by the compensation heater 3 and located between the compensation heater 3 and the airflow heater 2.

In some embodiments, referring to FIG. 19 and FIG. 20, the cigarette 1 includes a suction nozzle 12, a cooling section, and the aerosol substrate 11. The cooling section is located between the suction nozzle 12 and the aerosol substrate 11. The aerosol generated by the aerosol substrate 11 enters the cooling section to be cooled, and then enters the suction nozzle 12 for inhalation.

An embodiment of this application provides a hybrid heating device, including the hybrid heating device. The hybrid heating device heats the aerosol substrate by using the hybrid heating device to generate smoke.

In the hybrid heating device and the aerosol-generating device, the airflow heated by the airflow heater is a main force for baking the aerosol substrate to generate aerosol volatiles. The compensation heater is configured to compensate for a deficiency the downstream section of the aerosol substrate cannot be baked or cannot be fully baked due to a large temperature drop of the airflow when the aerosol substrate is long. Therefore, with cooperation between the airflow heater and the compensation heater, it is conducive to full use of the aerosol substrate to prevent the waste of the aerosol substrate, and a sufficient amount of aerosols is generated to improve the taste.

In the hybrid heating device and the aerosol-generating device, the compensation heater is located behind the upstream section of the aerosol substrate, and the heat generated by the compensation heater can increase the temperature of the aerosol substrate of the corresponding section, so that the temperature of the airflow heated by the airflow heater can be prevented from decreasing. Therefore, it can be ensured that the airflow heated by the airflow heater continues to bake the aerosol substrate outside of the upstream section, to generate a sufficient amount of volatiles.

In the hybrid heating device and the aerosol-generating device, the airflow has fluidity. Heating the aerosol substrate using the airflow can increase a heating area of the aerosol substrate, and can ensure that the aerosol substrate is heated evenly throughout, thereby generating a high-quality aerosol.

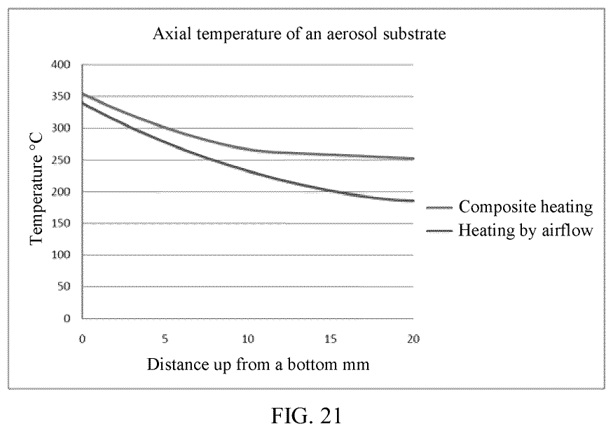

FIG. 21 is a schematic diagram of curves of detection results of temperature distribution detection performed by using an aerosol substrate with an axial length of 20 mm as an example. In the figure, a lower curve is a temperature distribution curve when the aerosol substrate is heated by using only the airflow heater, and an upper curve is a temperature distribution curve when the aerosol substrate is heated by using both the airflow heater and the compensation heater. A bottom of the aerosol substrate (or a starting position of the upstream section) is used as an origin, and it can be seen from the figure that when the aerosol substrate is heated by using only the airflow heater, the temperature of the section 10 mm up from the bottom of the aerosol substrate has decreased below 250° C., and the temperature at 20 mm up from the bottom of the aerosol substrate has decreased below 200° C., causing poor overall utilization of the aerosol substrate. When the aerosol substrate is heated by using both the airflow heater and the compensation heater, the temperature is above 250° C. in a section between 10 mm and 20 mm up from the bottom of the aerosol substrate, so that cigarette utilization can be effectively improved, to improve user experience.

It should be noted that, the specification of this application and the accompanying drawings thereof illustrate preferred embodiments of this application, but are not limited to the embodiments described in this specification, furthermore, a person of ordinary skill in the art may make improvements or modifications according to the foregoing description, and all the improvements and modifications shall fall within the protection scope of the attached claims of this application.

1. An aerosol-generating device, comprising:
an elongated cavity, configured to accommodate at least a part of an aerosol substrate;
an airflow heater, located upstream of the cavity, and configured to heat an airflow flowing to the cavity; and
a compensation heater, located in the cavity or arranged adjacent to the cavity, and configured to heat a local section of the aerosol substrate, wherein
the compensation heater is constructed to be spaced apart from the airflow heater in a longitudinal direction of the cavity, to enable a part of the aerosol substrate to be located between the compensation heater and the airflow heater when the aerosol substrate is accommodated into the cavity.

2. The aerosol-generating device according to claim 1, wherein the compensation heater is constructed to heat the aerosol substrate from outside in a circumferential direction of the cavity.

3. The aerosol-generating device according to claim 2, wherein the compensation heater comprises a heat conductive pipe and a heating member, the heat conductive pipe surrounds a part of the cavity, and the heating member is arranged on the heat conductive pipe.

4. The aerosol-generating device according to claim 2, wherein the compensation heater comprises an inductive heating pipe, the inductive heating pipe surrounds a part of the cavity, and the inductive heating pipe generates heat in an alternating magnetic field.

5. The aerosol-generating device according to claim 2, further comprising a connecting pipe, wherein the compensation heater is connected to the airflow heater through the connecting pipe.

6. The aerosol-generating device according to claim 1, wherein the compensation heater is configured to heat a midstream section or a downstream section of the aerosol substrate.

7. The aerosol-generating device according to claim 6, wherein the compensation heater comprises at least one heating element, and the heating element is coaxially arranged with the cavity, to heat the midstream section or the downstream section of the aerosol substrate located in the cavity.

8. The aerosol-generating device according to claim 1, wherein the airflow heater comprises a susceptor allowing an airflow to pass through, and the susceptor is configured to generate heat in an alternating magnetic field, to heat the airflow flowing through the susceptor.

9. The aerosol-generating device according to claim 8, wherein the susceptor is of a porous honeycomb structure.

10. The aerosol-generating device according to claim 8, wherein the susceptor comprises a plurality of magnetic inductors, are on each of the magnetic inductors is provided with a plurality of through holes for an airflow to pass through, the plurality of magnetic inductors are stacked on each other, and the through holes on adjacent magnetic inductors are at least partially in communication for the airflow to pass through.

11. The aerosol-generating device according to claim 8, wherein the susceptor comprises a material having a foam structure with continuous pores, and the material allows the airflow to pass through.

12. The aerosol-generating device according to claim 1, wherein the airflow heater comprises a heating element and a temperature balancer with a plurality of air holes, and the temperature balancer is thermally conductively connected to the heating element, to absorb heat of the heating element and release the heat to the air holes, to heat the airflow in the air holes.

13. The aerosol-generating device according to claim 12, wherein the heating element is constructed to surround at least a partial surface of the temperature balancer.

14. The aerosol-generating device according to claim 12, wherein the heating element is constructed into a surface heat source and is in contact with at least a partial surface of the temperature balancer.

15. The aerosol-generating device according to claim 12, wherein the heating element comprises a thin-film heater, a mesh heater, a heating coating layer, a strip heater, or a susceptor that generates heat by induction in an alternating magnetic field.

16. The aerosol-generating device according to claim 12, wherein the temperature balancer is made of a honeycomb ceramic, and the honeycomb ceramic is provided with several air holes that allows the airflow to pass through.

17. The aerosol-generating device according to claim 1, wherein the cavity comprises an open end configured to receive the aerosol substrate, and the compensation heater is located far away from the airflow heater and close to the open end.

18. The aerosol-generating device according to claim 1, wherein the compensation heater is configured to have an operating temperature lower than that of the airflow heater.

19. The aerosol-generating device according to claim 1, wherein the compensation heater and the airflow heater are configured to not be activated at the same time.

20. A hybrid heating device used in an aerosol-generating device, configured to heat an aerosol substrate to generate an aerosol, comprising:
an airflow heater, configured to heat an airflow;
a compensation heater, spaced apart from the airflow heater, and configured to heat a local section of the aerosol substrate; and
a connecting pipe, connected between the airflow heater and the compensation heater, wherein the connecting pipe is constructed to accommodate a part of the aerosol substrate and accommodate the airflow heated by the airflow heater, to enable the airflow to enter the aerosol substrate.
